(19) United States
(12) Patent Application Publication
(10) Pub. No.: US 2010/0049507 A1
(43) Pub. Date: Feb. 25, 2010

(54) APPARATUS FOR NOISE SUPPRESSION IN AN AUDIO SIGNAL

(75) Inventors: Erhard Rank, Wien (AT); Gernot Kubin, Graz (AT)

Correspondence Address: RATNERPRESTIA, P.O. BOX 980, VALLEY FORGE, PA, 19482, US

(73) Assignees: Technische Universitat Graz, Graz (AT); Forschungsholding TU Graz GmbH, Graz (AT)

(21) Appl. No.: 12/440,952

(22) PCT Filed: Sep. 6, 2007
(86) PCT No.: PCT/AT07/00424

§ 371 Date: Mar. 12, 2009

(30) Foreign Application Priority Data
Sep. 15, 2006 (AT) A 1547/2006

(51) Int. Cl. G10L 21/02; G10L 19/04

(52) U.S. Cl. 704/219; 704/226; 704/E19.023; 704/E21.002

(57) ABSTRACT

An apparatus for noise suppression having a linear prediction analysis circuit having an LP error filter (LFF), which takes a first, noisy voice signal y(n)=x(n)+ε(n) as a basis for producing an LP-error-filter output signal e(n), having a coefficient calculation unit (KBE), which updates the coefficients of the LP error filter on the basis of the internal signals (including the input and out signals y(n) and e(n)) in the LP error filter, and having a subtraction unit, which subtracts the LP error filter output signal e(n) from the first voice signal y(n) in a subtractor and, following the subtraction, outputs the remainder as a second voice signal x(n)=y(n)−e(n) in which the noise is suppressed. A noise estimation unit (GSE) is provided which takes the internal signals of the LP error filter as a basis for producing a noise power signal σₙ² and a voice power signal σₓ², these signals are applied to the coefficient calculation unit (KBE) and said signals are used by the latter for the purpose of optimizing the noise suppression.

The present invention pertains to an apparatus for noise suppression with a linear prediction analysis circuit with an LP error filter (LFF), which generates an LP error filter output signal e(n) on the basis of a first voice signal y(n)=x(n)+ε(n), to which noise is superimposed; with a coefficient calculation unit, which updates the coefficients of the LP error filter on the basis of the internal signals (including the input and output signals y(n) and e(n)) of the LP error filter; and with a subtraction unit, which subtracts the LP error filter output signal e(n) from the first voice signal y(n) in a subtractor and outputs the remainder after subtraction as a second voice signal x̂(n)=y(n)−e(n), in which the noise is suppressed.

Noise suppression in audio signals, especially also in voice signals, is of increasing significance, e.g., in telephony, automatic voice recognition or, as only one of many other examples, in digital hearing aids. Noises that are to be suppressed are primarily non-white noise, nonstationary noise and highly pulse-like noise.

Many different methods for noise suppression for audio signals have become known and shall be mentioned as examples: Methods in which faint audio signals are at first raised and again lowered later, such as pre/deemphase for radio or the Dolby noise suppression methods for tape recording. Furthermore, methods of spectral subtraction, in which, e.g., the noise is estimated during voice pauses and then subtracted from the input signal. The latter methods also include Wiener filters as well as Ephraim-Malah filters with adaptive amplification for signals split into a plurality of transformation channels. Some of the prior-art methods are not very effective, because they are based on a highly simplified model of the noise signal, or they lead, because of a block-by-block processing of the input signal, to artifacts, which become noticeable as unpleasant secondary noise, as so-called musical tones, which remain in the signal after the noise reduction. Many methods also lead to a relatively great delay of the output signal.

The state of the art, on which the present invention is based, are linear prediction filters (LP filters), in a direct form or in the lattice form (cross member chain filter), in which properties of the entire input signal are used to set the filter coefficients. A corresponding apparatus, as disclosed, e.g., in US 2001/0005822 A1, comprises a lattice filter, to which an input signal y(n) is sent, which has a voice/audio component as well as a noise component. A coefficient calculation unit KBE, to which the forward and backward error signals, which also contain the input signal in the first step, are sent, is provided for setting the components. The coefficient calculation unit then sends filter coefficients, which are always updated in the sense of minimization of the prediction error, to the filter. Noise reduction with the use of linear prediction filters is disclosed, among other things, in GB 1 520 148 A or in U.S. Pat. No. 4,587,620. The methods and devices according to the state of the art are always based on the input signal, without the special properties of the voice signal, on the one hand, and of the noise, on the other hand, being taken into account.

In the apparatus according to U.S. Pat. No. 7,065,468, the input signal is used to determine the coefficients for the prediction filter (units 212 as well as 312 and 318, respectively), and an estimation of the voice signal is then performed on the basis of these coefficients, and, using an additional voice activity estimation unit (VAD, unit 232 and 332, respectively), an estimation of the noise signal is performed, namely in a unit 234 and 334, respectively, in order to perform noise suppression by means of an additional second filter (unit 240 and 340, respectively).

Essential features are that the estimation of the coefficients of the linear prediction filter (unit 214) and of the linear prediction filter (units 314 and 320 in FIG. 3) is performed only with the use of the input signal (or error signal of the first prediction filter e ST(n) (path 316)). Another essential difference from the present invention is that a voice activity estimation is carried out independently from the linear prediction filter 214 by the linear prediction filters 314 and 320, as well as that the filter proper for noise suppression (units 240 and 340) itself does not represent a linear prediction filter. The noise estimation (“Update Noise Model”) is performed only on the basis of the prediction error (cf. claim 1 of U.S. Pat. No. 7,065,468), whereas, as will be described below, the noise estimation is carried out in the present invention on the basis of the internal signals of the LP error filter. This difference is also apparent from FIG. 2 of U.S. Pat. No. 7,065,468.

On the whole, U.S. Pat. No. 7,065,468 shows a structure, which already differs from the state of the art according to US 2001/0005822 A1 and which is, moreover, more complicated than the present invention. A different approach is ultimately taken in U.S. Pat. No. 7,065,468, which would lead the person skilled in the art, to whom US 2001/0005822 A1 is known and who has set before himself the object underlying the present invention, in a different direction than the approach shown by the present invention.

Furthermore, the following publications shall be cited as publications pertaining to this field:

[1] J. D. Markel and A. H. Gray, Jr., Linear Prediction of Speech. Berlin, Heidelberg, New York: Springer, 1976.

[2] J. I. Makhoil and L. K. Cosell, “Adaptive lattice analysis of speech,”, IEEE Transactions on Acoustics, Speech, and Signal Processing, Vol. 29, pp. 654-659, June 1981.

[3] M. L. Honig and D. G. Messerschmidt, Adaptive Filters: Structures, Algorithms, and Applications. The Hague-London-Lancaster: Kluwer Academic Publishers, 1984.

[4] A. Kawamura, K. Fujii, Y. Itoh, and Y. Fukui, “A noise reduction method based on linear prediction analysis,” Electronics and Communications in Japan, Part 3, Vol. 86, No. 3, pp. 1-10, 2003.

[5] M. H. Savoji, “Effective noise reduction of speech signals using adaptive lattice filtering, segmentation and soft decision,” in IEE Colloquium on New Directions in Adaptive Signal Processing, pp. 7/1-7/5, February 1993.

One object of the present invention is to create an apparatus and a method for noise suppression for audio signals, especially for voice signals, which yields a practically undelayed output audio signal, which is also free from interfering artifacts.

This object is accomplished with an apparatus of the type mentioned in the introduction, in which a noise estimation unit is provided according to the present invention, which generates a noise power signal and a voice power signal on the basis of the internal signals of the LP error filter, sends these signals to the coefficient calculation unit, and they are taken into account by this in the sense of optimization of noise suppression, and/or a voice activity estimation unit is provided, which generates a voice activity signal on the basis of the internal signals of the LP error filter, and this voice activity signal is sent to the coefficient calculation unit and is taken into account by same in the sense of optimization of noise suppression.

Provisions are made in an advantageous variant of the present invention for the voice activity estimation unit to form a noise suppression factor kₙ, which is sent to an input of a first multiplier, and the output signal of the LP error filter is sent to the other input thereof and said input is located upstream of the subtractor.

Furthermore, it may be advantageous if the voice activity estimation unit forms an overall signal factor k_{g}, which is sent to an input of a second multiplier and the output signal of the subtractor is sent to the other input thereof.

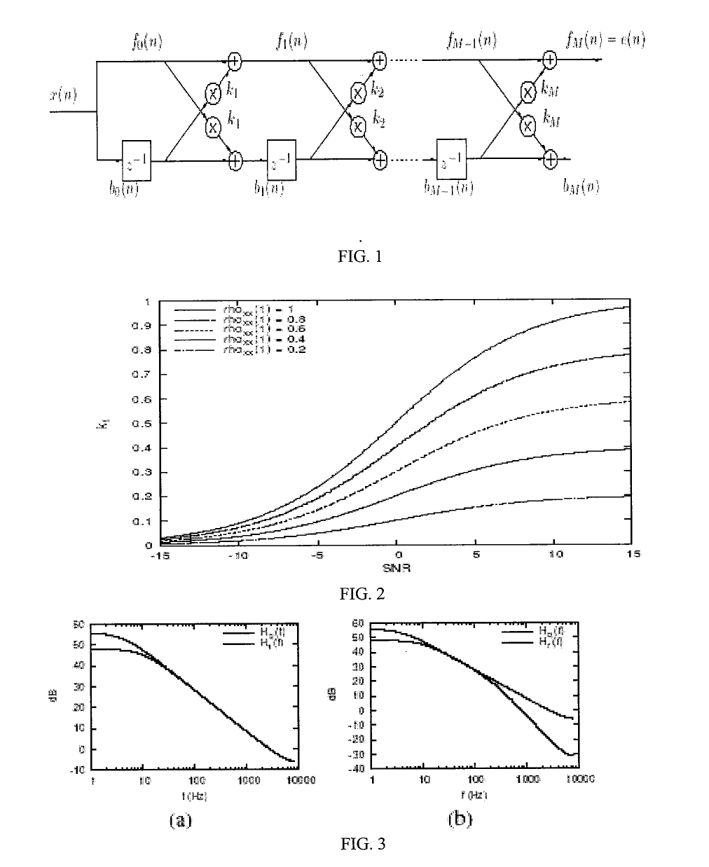

Provisions may be made in a practical variant for the LP error filter to comprise a lattice filter (FIG. 1), wherein the forward and backward error signals represent the internal signals of the LP error filter.

On the other hand, it is advantageously also possible that the LP error filter produces as a filter in the direct filter form a prediction signal from the input signal at its output and that a subtractor subtracts the prediction signal from the input signal and thus generates the output signal of the LP error filter e(n), the delayed scanned values of the input signal (cf. Equation 1) as well as the output signal of the subtractor e(n) corresponding to the internal signals of the LP error filter.

Provisions are made in another advantageous variant for the coefficient calculation unit to be set up to determine the corrected error variance \hat{q}₀ according to

\hat{q}₀=q₀−σₙ²

and the corrected reflection coefficient \hat{k} according to

$${\hat{k}}_{1} = - \frac{{\hat{r}}_{0}}{{\hat{q}}_{0}} = - \frac{{r}_{0}}{{q}_{0} - {σ}_{n}^{2}}$$

Yet another advantageous variant is characterized in that the coefficient calculation unit is set up to determine the error correlation according to

\tilde{r}ₘ(n)=λᵣ\tilde{r}ₘ(n−1)+fₘ(n)bₘ(n−1)

and the error variance according to

$${\tilde{q}}_{m} ( n ) = {λ}_{q} {\tilde{q}}_{m} ( n - 1 ) + \frac{1}{2} ( {f}_{m}^{2} ( n ) + {b}_{m}^{2} ( n - 1 ) )$$

In a favorable embodiment, a single-pole low-pass filter may be provided for the power estimation of \tilde{q}(n) and a two-pole low-pass filter may be provided for the correlation estimation \tilde{r}(n).

To improve the noise suppression with a correspondingly increased effort, another variant of the present invention provides for a cascade, which comprises at least two series-connected apparatuses, which are designed corresponding to the above-mentioned inventive features.

The present invention as well as further advantages will be explained in more detail below on the basis of exemplary embodiments, which are shown in the drawings. In these drawings,

FIG. 1 shows a lattice filter according to the state of the art,

FIG. 2 shows values of the reflection coefficient calculated from the noisy signal without correction in a diagram,

FIGS. 3a and b show the frequency curve of low-pass filters used within the framework of the present invention,

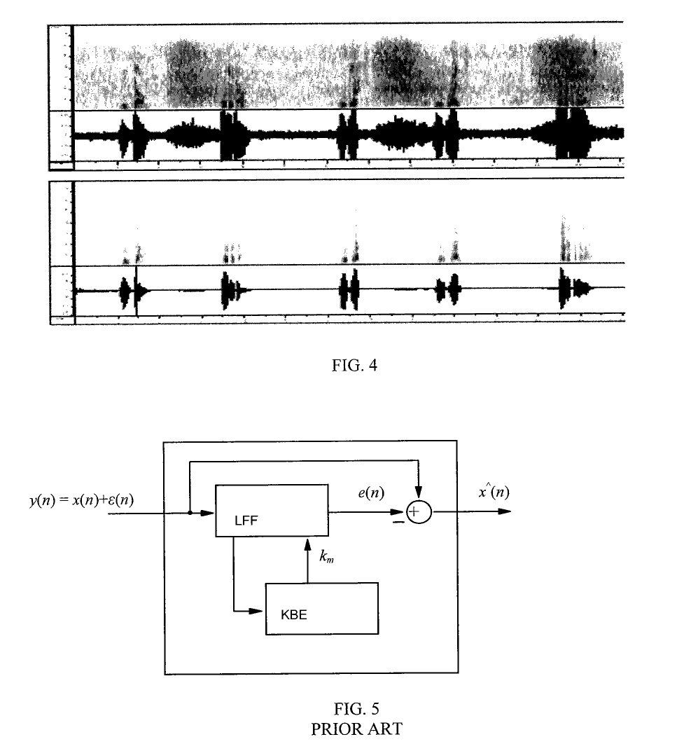

FIG. 4 shows on the basis of the time curve as well as the spectrogram of a noisy input signal (top) and the noise suppression of said input signal (bottom) according to the present invention,

FIG. 5 shows the block diagram of a schematic apparatus for noise suppression according to the state of the art,

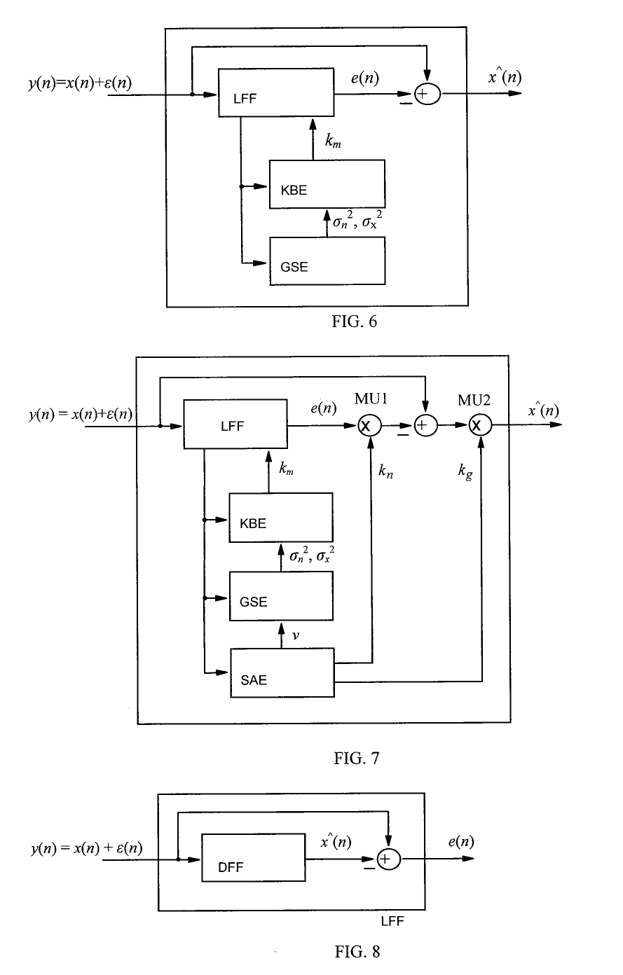

FIG. 6 shows the block diagram of a first embodiment of an apparatus according to the present invention,

FIG. 7 shows the block diagram of a second embodiment of an apparatus according to the present invention, and

FIG. 8 shows the block diagram of a third embodiment of an apparatus according to the present invention.

Linear prediction is usually applied to a voice signal x(n), for example, in order to reduce the variance of a voice signal for transmitting same. To predict a signal value, FIR filters (finite impulse response filters, filters with finite impulse response) of a low order, which are changing slowly over time, are used to predict a signal value:

$$\hat{x} ( n ) = {\sum }_{i = 1}^{M} {b}_{i} ( n ) x ( n - i ) . \qquad ( 1 )$$

Here, M denotes the order of the LP filter and bᵢ(n) the filter coefficients, which are estimated on the basis of the signal properties and are updated frame by frame, e.g., every 10 msec. Algorithms, which directly yield the coefficients bᵢ(n) for the filter, are the so-called “autocorrelation methods” or the “covariance method.” The filter order usually used to model the spectral enveloping curve is M=10 . . . 20, depending on the rate of scanning.

The already mentioned lattice filter, which has a direct relationship to the human organ of speech, is equivalent to the direct FIR filter just described, to which patent claim 7 pertains [1].

Such a filter is characterized by the equations

f₀(n)=b₀(n)=x(n)

fₘ(n)=fₘ₋₁(n)+kₘ(n)bₘ₋₁(n−1), (2)

bₘ(n)=bₘ₋₁(n−1)+kₘ(n)fₘ₋₁(n). (3)

which are calculated for each point in time n for all filter stages m=1 . . . M. Here, fₘ(n) and bₘ(n) designate the forward and backward errors, respectively, in step m at the time n and kₘ(n) designates the reflection coefficients of the filter. It shall be noted here that the reflection coefficients in (2) and (3) are different in a generalized representation, but equal reflection coefficients are used here forward and backward. FIG. 1 schematically shows a lattice filter as was just described. For example, patent claim 6 pertains to such a filter.

The forward error in step M is the predicted error signal of the LP filter:

f_{M}(n)=e(n)=x(n)−\hat{x}(n). (4)

Optimal reflection coefficients km for minimizing the root mean square value of the prediction error of an undistorted signal are obtained as:

$${k}_{m} ( n ) = - \frac{{r}_{m - 1} ( n )}{{q}_{m - 1} ( n )} . \qquad ( 5 )$$

with the expected values for the forward and backward error correlation or power:

$$\begin{matrix}{r}_{m} ( n ) = E \{ {f}_{m} ( n ) {b}_{m} ( n - 1 ) \} , & ( 6 ) \\ {q}_{m} ( n ) = \frac{1}{2} E \{ {f}_{m}^{2} ( n ) + {b}_{m}^{2} ( n - 1 ) \} . & ( 7 )\end{matrix}$$

The expected value operators E in (6) and (7) are usually analyzed with the use of low-pass-filtered instantaneous values of fₘ(n)bₘ(n−1) and fₘ²(n)+bₘ²(n−1), for example, by means of one-pole recursive low-pass filters (“lossy integration,” see below).

Thus, the adaptation of the lattice filter to form the slowly changing input voice signal is performed by calculating Equations (6), (7) and (5) for each point in time n after filtering—contrary to the frame-by-frame updating of the coefficients in the direct form of the LP filter corresponding to Equation (1).

As far as the noise reduction is concerned, it shall be assumed that an observed signal y(n) of an additive linear noise model is present:

y(n)=x(n)+ε(n), (8)

in which x(n) shall be the voice component and ε(n) an additive background noise component. The subject of noise reduction is to provide a good estimate for the voice signal component x(n). For the present single-channel case, this estimation is based exclusively on the observation of the noisy signal y(n), i.e., no additional information, for example, a second signal of a microphone, which picks up only the background noises, is used.

Background noise reduction in voice signals with the use of linear prediction filtering can be based on the assumption that the voice signal component is well predictable, whereas the noise component does not possess this property. The above-mentioned signal \hat{x}(n) can thus be used as an estimate for the voice component. While the output is directly the predicted signal in the prediction filters in the direct form in Equation (1), it is calculated effectively as the difference between the input signal and the output signal of the forward prediction path in lattice filters \hat{x}(n):

x(n)=y(n)−e(n) (9)

\hat{x}(n) is the estimate the voice component with e(n)=f_{M}(n). Compare Equation (4).

If a lattice LP filter is used for noise reduction according to A. Kawamura et al., where a high-order filter (N=256) is used to model the fine spectral structure of speech, it can be observed that rₘ(n) has a great variance because of the noise signal component in the higher filter stages. It is proposed that the corresponding variance of the reflection coefficients be reduced by using a fixed (high) value for the power estimations qₘ(n)=G. The reduction of the value of the reflection coefficients or the reduction of the radii of the zero points of the LP filter transmission function was proposed for other purposes as well, e.g., for modeling the spectral enveloping curve or for a more accurate estimation of the formats.

The value of the reflection coefficients can be reduced by deriving estimators for rₘ and qₘ, which minimize the root mean square estimation error. White noise with the variance σₙ². which also shall not be correlated with x(n), shall be assumed for the additional noise signal to calculate the reflection coefficients for the lattice filter or the partial correlations, which equal −kₘ and are based on the estimations of a noise signal. This represents the least informed model (maximum entropy).

Even though this assumption is not, in general, realistic for ambient noise, it does prove the need for correcting the reflection coefficients.

The estimations for the correlation in Equation (6) and the power in Equation (7) from the calculation of the reflection coefficients in Equation (5) are now based on the noisy observed signal y(n) and the need for a correction term to obtain the estimations for the reflection coefficients \hat{k}ₘ relative to the noise-free signal x(n) can be shown.

In particular, the following expected value is obtained for r₀ for the estimation of the reflection coefficients in the first filter stage m=1:

$$\begin{matrix}\begin{matrix}{r}_{0} = E \{ {f}_{0} ( n ) {b}_{0} ( n - 1 ) \} \\ = E \{ y ( n ) y ( n - 1 ) \} \\ = E \{ ( x ( n ) + ɛ ( n ) ) ( x ( n - 1 ) + ɛ ( n - 1 ) ) \} \\ = E \{ x ( n ) x ( n - 1 ) \}\end{matrix} & ( 10 ) \\ \begin{matrix}{q}_{0} = \frac{1}{2} E \{ {f}_{0}^{2} ( n ) + {b}_{0}^{2} ( n - 1 ) \} \\ = \frac{1}{2} E \{ {y}^{2} ( n ) + {y}^{2} ( n - 1 ) \} \\ = \frac{1}{2} E \{ {( x ( n ) + ɛ ( n ) )}^{2} + {( x ( n - 1 ) + ɛ ( n - 1 ) )}^{2} \} \\ = \frac{1}{2} E \{ {x}^{2} ( n ) + {x}^{2} ( n - 1 ) \} + {σ}_{n}^{2} ,\end{matrix} & ( 11 )\end{matrix}$$

is obtained for the error variance q₀ in the first filter stage.

The resulting error in the values of the reflection factors is shown in FIG. 2. More precisely, values of the reflection coefficient k₁ calculated from the noisy signal without correction are illustrated here as a function of an a priori signal-to-noise distance for different values of the autocorrelation ρₓₓ(1) of the interference-free signal x(n).

As far as the reflection coefficients related to the noise-free signal x(n) are concerned, the correlation estimation from the noisy observation can be used without any change, i.e., \hat{r}₀=r₀, whereas the calculated error power estimation is to be corrected as

\hat{q}₀=q₀−σₙ² (12)

and the corrected reflection coefficient is calculated as

$${\hat{k}}_{1} = - \frac{{\hat{r}}_{0}}{{\hat{q}}_{0}} = - \frac{{r}_{0}}{{q}_{0} - {σ}_{n}^{2}} \qquad ( 13 )$$

When introducing

$$γ = \frac{E \{ {y}^{2} \}}{{σ}_{n}^{2}}$$

in which

$$γ - 1 = \frac{E \{ {y}^{2} \} - {σ}_{n}^{2}}{{σ}_{n}^{2}}$$

is the signal-noise distance determined a posteriori, and it is borne in mind that

$${q}_{0} = \frac{1}{2} E \{ {f}_{0}^{2} ( n ) + {b}_{0}^{2} ( n - 1 ) \} ,$$

this equation can be rewritten as

$${\hat{k}}_{1} = - \frac{1}{1 - \frac{{σ}_{n}^{2}}{{q}_{0}}} \frac{{r}_{0}}{{q}_{0}} = - \frac{1}{1 - \frac{1}{γ}} {k}_{1} \qquad ( 14 )$$

This means a scaling of the reflection coefficient k₁, which was originally calculated for the signal with interference y(n) with the use of Equations (5), (6) and (7) with a factor

$$\frac{1}{1 - \frac{1}{γ}}$$

The noise power σₙ² can be estimated on the basis of the power of the output signal e(n) of the LP error filter,

σₙ²=E{e(n)},

a possible analysis of the expected value is given for the lattice filter by the power estimation in the last stage of the lattice filter q_{M-1}(n):

σₙ²=q_{M-1}(n),

or, when the voice activity estimation (see below) is used on the basis of the power estimation of the overall input signal in the absence of voice activity:

σₙ²=q₀(n) when v≈0

Equation (14) can be generalized for the higher lattice stages m=2, 3, . . . , as a result of which a correction of the other reflection coefficients \hat{k}ₘ is obtained.

Regardless of this, it can be concluded from the above that a reduction of the value of the reflection coefficients, i.e., a reduction of the ratio of the correlation to the power estimation, is useful for the prediction of a signal x(n) when a signal y(n) is observed, which contains additional noise. Finding the correction variables requires a reliable estimation of the noise power σₙ². Furthermore, the model does not take into account so far any information concerning the properties of speech and of the noise signal to be expected.

The present invention provides a method and an apparatus with which a correction of the reflection factors is obtained based on simple assumptions on the change in the correlation and the power of the voice and noise signals. As was stated above, the estimations of the error correlation (6) and of the error variance (7) are usually based on a low-pass filtration of the instantaneous values. A one-pole low-pass filtering (lossy integration) is frequently used as well:

$$\begin{matrix}{\tilde{r}}_{m} ( n ) = {λ}_{r} {\tilde{r}}_{m} ( n - 1 ) + {f}_{m} ( n ) {b}_{m} ( n - 1 ) & ( 15 ) \\ {\tilde{q}}_{m} ( n ) = {λ}_{q} {\tilde{q}}_{m} ( n - 1 ) + \frac{1}{2} ( {f}_{m}^{2} ( n ) + {b}_{m}^{2} ( n - 1 ) ) & ( 16 )\end{matrix}$$

with the same poles and integration factors λᵣ=λ_{q} for estimating both the correlation and the power.

In agreement with the present invention, various pole positions λ_{q}≧λᵣ are allowed. The resulting filter functions

$${H}_{r} ( z ) = \frac{1}{1 - {λ}_{r} {z}^{- 1}} , \\ {H}_{q} ( z ) = \frac{1}{1 - {λ}_{q} {z}^{- 1}} , \qquad ( 17 )$$

for λᵣ=0.99608 and λ_{q}=0.99843 and a scanning rate of 16 kHz are shown in FIG. 3a. It can be seen that the ratio of \tilde{r}ₘ(n) and \tilde{q}ₘ(n) is affected at lower frequencies, i.e., for slowly changing correlation and power, whereas the ratio remains unchanged compared to the estimations with λᵣ=λ_{q} for more rapid changes (above≈10 Hz). Assuming that these parameters change more rapidly for the voice signal (assuming, for example, a phoneme rate of 10 per second) than for the noise signal (stationary noise or noise changing slowly over time), the lattice prediction filter obtained will well predict the voice signal component, whereas the noise component is suppressed.

As far as pulse-like noises are concerned, provisions may be made for reducing the ratio of the correlation to the power estimation for high frequencies as well, which can be performed, for example, by using a second pole in the low-pass filter for the correlation Hᵣ(z). FIG. 3b shows a corresponding transmission function.

In detail, FIGS. 3a and b show the frequency responses of a low-pass filter for an error correlation Hᵣ(z) (solid lines) and the variance H_{q}(z) (dotted lines) for two one-pole low-pass filters with λᵣ=0.99608 and λ_{q}=0.99843 in Figure a or for a one-pole low-pass [filter] in FIG. 3b for the power estimation of \tilde{q}(n) with λ_{q}=0.99843 and a two-pole low-pass [filter] for the correlation estimation \tilde{r}(n) with λᵣ₁=0.99608 with λᵣ₂=0.9. The greater the distance between the two transmission functions, the greater is the noise suppression.

To achieve good noise reduction, the order M of the LP filter can be selected as a surprisingly low order under these circumstances, even lower than the order usually used to model the spectral enveloping curve of voice signals. For example, a predictor with the order M=10 was used for a signal with a scanning rate of 16 kHz in the example shown in FIG. 4a. This example contains multiple occurrence of strong, nonstationary noise bursts, which are well eliminated thanks to the present invention. The noise shown originates from a factory building environment, i.e., an extremely unfavorable acoustic environment.

The effectiveness of noise suppression can be controlled by setting different values for λᵣ (or λᵣ₁ and λ_{r2) and λ}_{q}. These are selected as a function of the signal power and the noise power:

(λᵣ,λ_{q})=f(σₓ²,σₙ²), (bzw.(λᵣ₁,λᵣ₂,λ_{q})=g(σₓ²,σₙ²). (18)

Furthermore, it is advantageous to control the effectiveness of noise suppression on the basis of an estimation of the voice activity. If an LP error filter is used, it is possible (cf. [5]) to estimate the probable voice activity as a real number in the range of 0 to 1 on the basis of the powers of the filter input signal and the filter output signal:

$$v = \frac{E \{ {y}^{2} ( n ) \} - E \{ {e}^{2} ( n ) \}}{E \{ {e}^{2} ( n ) \}}$$

A possible analysis of the expected values is given for a lattice filter by

$$v = \frac{{q}_{0} ( n ) - {q}_{M - 1} ( n )}{{q}_{M - 1} ( n )}$$

A factor

kₙ=1−v

for the output signal of the lattice filter e(n) and/or a factor

k_{g}=v

for the output signal can be used to control the noise suppression.

The LP error filter may be designed as a filter in a direct filter form (DFF), which generates a prediction signal at its output from the input signal, a subtractor subtracts the prediction signal from the input signal and thus generates the LP error filter e(n). The delayed scanned values of the input signal (cf. Equation 1) as well as the output signal of the subtractor e(n) correspond to the internal signals of the LP error filter.

An important feature of the noise suppression according to the present invention is the analysis of the expected value operators adapted to the properties of the voice signal and to the noise signal and hence the optimal setting of the filter coefficients for the linear prediction filter, as well as the voice activity estimation and the use thereof in the estimation of the noise signal and for controlling the effectiveness of noise suppression and of the output signal amplitude.

Even though it should be clear that the effort needed for calculation increases with the filter order selected and the effort needed for calculation may therefore be greater than in case of the use of a fast Fourier transformation, an essential advantage of the present invention is that it makes noise reduction possible without delay of the voice signal, which is a special advantage, above all in case of the use in hearing aids.

1. An apparatus for noise suppression comprising:
a linear prediction analysis circuit with an LP error filter (LFF), which generates an LP error filter output signal e(n) on the basis of a first voice signal y(n)=x(n)+ε(n), to which noise is superimposed;
a coefficient calculation unit (KBE), which updates coefficients of the LP error filter on the basis of internal signals (including the input and output signals y(n) and e(n)) of the LP error filter;
a subtraction unit, which subtracts the LP error filter output signal e(n) from the first voice signal y(n) in a subtractor and outputs the remainder after subtraction as a second voice signal \hat{x}(n)=y(n)−e(n), in which the noise is suppressed; and
a noise estimation unit (GSE), which generates a noise power signal σₙ² and a voice power signal σₓ² on the basis of the internal signals of the LP error filter, these signals are sent to the coefficient calculation unit (KBE) and are taken into account by the coefficient calculation unit for optimization of noise suppression.

2. An apparatus for noise suppression comprising:
a linear prediction analysis circuit with an LP error filter, which generates an LP error filter output signal e(n) on the basis of a first voice signal y(n)=x(n)+ε(n), to which noise is superimposed;
a coefficient calculation unit, which updates the coefficients of the LP error filter on the basis of the internal signals of the LP error filter;
a subtraction unit, which subtracts the LP error filter output signal from the first voice signal and outputs the remainder after subtraction as a second voice signal \hat{x}(n)=y(n)−e(n), in which the noise is suppressed; and
a voice activity estimation unit (SAE), which generates a voice activity signal v on the basis of the internal signals of the LP error filter, and said voice activity signal v is sent to the coefficient calculation unit (KBE) and is taken into account by the coefficient calculation unit for optimization of noise suppression.

3. An apparatus for noise suppression comprising:
a linear prediction analysis circuit with an LP error filter, which generates an LP error filter output signal on the basis of a first voice signal, to which noise is superimposed;
a coefficient calculation unit, which updates the coefficients of the LP error filter on the basis of the internal signals of the LP error filter;
a subtraction unit, which subtracts the LP error filter output signal from the first voice signal, and outputs the remainder after subtraction as a second voice signal, in which the noise is suppressed;
a noise estimation unit (GSE);
a voice activity estimation unit (SAE), the internal signals of the LP error filter are sent to the noise estimation unit and the voice activity estimation unit, and the units generate on the basis of these signals a noise power signal σₙ², a voice power signal σₓ² and a voice activity signal v, which are sent to the coefficient calculation unit (KBE) and are taken into account by the coefficient calculation unit for optimization of noise suppression.

4. The apparatus in accordance with claim 2, wherein the voice activity estimation unit (SAE) forms a noise suppression factor (kₙ), which is sent to an input of a first multiplier (MU1) and the output signal of the LP error filter is sent to the other input thereof, and the input is located upstream of the subtractor (SUB).

5. The apparatus in accordance with claim 2, wherein the voice activity estimation unit (SAE) forms an overall signal factor (k_{g}), which is sent to an input of a second multiplier (MU2) and the output signal of the subtractor (SUB) is sent to the other input thereof.

6. The apparatus in accordance with claim 1, wherein the LP error filter comprises a lattice filter, wherein forward and backward error signals represent the internal signals of the LP error filter.

7. The apparatus in accordance with claim 1, wherein the LP error filter, as a filter in the direct filter form (DFF), generates a prediction signal from the output signal at its output, and a subtractor subtracts the prediction signal from the input signal and thus generates the output signal of the LP error filter e(n), wherein delayed scanned values of the output signal as well as the output signal of the subtractor e(n) correspond to the internal signals of the LP error filter.

8. The apparatus in accordance with claim 1, wherein the coefficient calculation unit (KBE) is set up to determine a corrected error variance \hat{q}₀ according to
\hat{q}₀=q₀−σₙ²
and a corrected reflection coefficient \hat{k} according to
$${\hat{k}}_{1} = - \frac{{\hat{r}}_{0}}{{\hat{q}}_{0}} = - \frac{{r}_{0}}{{q}_{0} - {σ}_{n}^{2}}$$

9. The apparatus in accordance with claim 1, wherein the coefficient calculation unit (KBE) is set up to determine an error correlation according to
\tilde{r}ₘ(n)=λᵣ\tilde{r}ₘ(n−1)+fₘ(n)bₘ(n−1)
and an error variance according to
$${\tilde{q}}_{m} ( n ) = {λ}_{q} {\tilde{q}}_{m} ( n - 1 ) + \frac{1}{2} ( {f}_{m}^{2} ( n ) + {b}_{m}^{2} ( n - 1 ) )$$

10. The apparatus in accordance with claim 1, further comprising a one-pole low-pass filter for the power estimation of \hat{q}(n) and a two-pole low-pass filter is provided for the correlation estimation.

11. (canceled)

12. The apparatus in accordance with claim 3, wherein the voice activity estimation unit (SAE) forms a noise suppression factor (kₙ), which is sent to an input of a first multiplier (MU1) and the output signal of the LP error filter is sent to the other input thereof, and the input is located upstream of the subtractor (SUB).

13. An apparatus for noise suppression comprising at least two of said apparatus of claim 1 connected with one another in a cascade configuration.
